(19) United States
(12) Patent Application Publication
(10) Pub. No.: US 2017/0062079 A1
(43) Pub. Date: Mar. 2, 2017

(54) Method for inducing an exothermic reaction in a liquid solution

(71) Applicant: Brian P. Roarty, Los Altos, CA (US)

(72) Inventor: Brian P. Roarty, Los Altos, CA (US)

(21) Appl. No.: 14/756,325

(22) Filed: Aug. 25, 2015

(51) Int. Cl. G21B 3/00

(52) U.S. Cl. CPC G21B 3/00

(57) ABSTRACT

By preparing, enclosing in a container, and stimulating a liquid solution (light and/or heavy water forming the solvent, a silicate with Group I ionic metal, and a organometallic molecule having a siliceous ring or cage to which the Group I ions may enter as a guest, as first and second solutes), and applying electrical and photonic stimuli between conductive electrodes immersed in the solution maintained at or near the solution's boiling point, desired exothermic reactions can be induced. Preferably the first solute is soluble polyhedral silsesquioxane (‘POSS’) that serves as a host to lithium ions in the solution, thereby forming a lithium silicate, which is necessary to the reaction and, after the solution is heated to within 5° C. of the solution's current boiling point, a pressure release may be affected.

### CROSS-REFERENCES TO RELATED APPLICATIONS

This application claims priority under USC119(e) from U.S. Provisional Patent Application Ser. No. 62/041,772 titled “Material Surface Treatment Method Using Concurrent Electrical and Photonic Stimulation in a Solution With Polyhedral Silsesquioxane” dated Aug. 26, 2014, which is herein expressly incorporated by reference.

### GOVERNMENT RIGHTS

None

### FIELD OF THE INVENTION

The invention relates to combining the preparation of a liquid solution, the surface treatment of materials of and in a system, and through said system applying to said liquid solution specific stimuli, as a method of facilitating and initiating certain desirable exothermic reactions.

### BACKGROUND OF THE INVENTION

U.S. Pat. No. 7,442,287 describes a surface treatment method of preparing materials, such as palladium, at or near their surfaces in order to facilitate their use, e.g., for coating the material and generating exothermic reactions. In that treatment method, a solution in water of an electrolyte, a soluble silicate that is also a surfactant, and a pH-adjusting agent (to maintain the pH of the solution between 6.5 and 8.9) is heated to and maintained at or just below the boiling point in an open glass beaker. A pair of electrodes, at least one of which has the surface to be treated, is immersed in the solution with a gap between them. The electrodes are then electrically (and vibrationally) stimulated with a series of modulated pulses, while simultaneously being photonically stimulated by a light source. Scanning electron microscope (SEM) images of the treated electrodes show that the concurrent stimulations of the electrode material while immersed in the hot solution leave a silica coating with a stratified and sponge-like texture; in some instances crater sites form on the electrode surface.

The metallic surface treated by the method provides enhanced sites for facilitating desired reactions, e.g., hydrogen absorption and release, hydrogenation, catalytic reactions, and exothermic reactions. Palladium, e.g., is known to have a large capacity for hydrogen storage and release, useful for fuel cells and the like, the level of performance of which depends on the presence of certain surface sites for efficient hydrogen exchange.

U.S. patent application publications 2011/0174632 and 2013/0233718 (a CIP to '632) describe improvements to the patented method described above. Specifically, the protocol was implemented in a sealed reactor and other silicates were used in place of anionic silica hydride. In that application, the role of a lithium silicate in the reaction was detailed and evidence was presented of possible transmutation products on the surface of some treated electrodes. Silica molecules with cages and rings can function as hosts for guest lithium ions, and that mechanism was described as the process by which the lithium was bonding to the silica to form a lithium silicate.

Conventionally, reactions are divided into two classes: 1) chemical reactions, and 2) nuclear reactions. Chemical reactions involve the exchange or sharing of valence electrons between atoms and result in the formation or breaking of molecular bonds. Nuclear reactions involve the subatomic particles in an atom's nucleus. They generally only occur in three ways: a) with the natural decay of radioactive elements, b) within a plasma where the elevated temperatures strip the atoms of their valence electrons and nuclei are sufficiently energetic to interact with each other and overcome the repulsion provided by the Coulomb effect of the valence electrons, and c) when atoms are bombarded by high-energy particles that can penetrate the electrons surrounding a nucleus, as in a particle accelerator.

The reactions described in b) and c) above require high energies, and they could be called High-Energy Nuclear Reactions (HENRs). In contrast, LENRs do not require high energies. They are called “low-energy” reactions precisely because they are stimulated by relatively low-energy inputs and occur at relatively low temperatures, compared to HENRs. However, LENRs have the high energy density of HENRs. Fortunately, LENRs are also surface reactions, limited in the case of this invention to the interface between the solid electrode and the liquid in which it is immersed.

LENRs are sometimes conflated with “cold fusion”. Cold fusion is generally understood by people in that field to follow the Fleishman-Pons model, where deuterium atoms are loaded into the crystalline matrix of a metal. They are thus immobilized within the matrix and can interact with each other in ways that are not possible as a gas. The reaction described in this patent does not require the loading of either hydrogen or deuterium atoms into a material at the site of the reaction, although it resembles the Fleishman-Pons protocol in some ways.

### SUMMARY

The present invention is a further improvement of the previous methods set forth in the aforementioned U.S. Pat. No. 7,442,287 and subsequent U.S. patent application publications 2011/0174632 and 2013/0233718. Similar to before, the protocol consists of a specific series of steps in a system having at least two conductive electrodes of applying electrical and photonic stimuli while the conductive electrodes are immersed in a solution maintained at an elevated temperature at or near the solution's current boiling point with no inhibiting substances in contact with the solution or electrodes. The solution is prepared by combining as the solvent an aqueous liquid, with a first solute being an electrolyte including Group I element ions capable of being hosted in a hosting siliceous element, and a second solute providing the hosting siliceous element. However, in the present protocol, in the preferred embodiment solution includes a soluble polyhedral silsesquioxane (‘POSS’) that serves as a host to lithium ions in the solution, thereby forming a lithium silicate, which is necessary to the reaction. The solution is typically heated to within 5° C. of the solution's boiling point.

Five different experiments were performed in a sealed reactor. All of the experiments used palladium electrodes. Distinct temperature spikes were observed in four of those experiments. The fifth experiment showed less distinct temperature spikes, but it showed radiation several times greater than background levels when the solution was in the temperature range of interest, thereby providing additional evidence that the observed reaction may be nuclear in nature.

During one experiment, the pressure in the reactor was lowered deliberately and manually. That action initiated an exothermic reaction.

### BRIEF DESCRIPTION OF THE DRAWINGS

FIG. 1 is a ¾ side perspective external view of the container, and its respective elements, used in the datalogged experiments and method.

FIG. 2 is a cut-away side view of the container and its interior with both its respective elements and the liquid solution therein, as they would be when the stimulating steps are made.

FIG. 3 is a cut-away side view of the preferred embodiment of the container with a controllable exhaust valve.

FIG. 4 shows a signal emitted during testing of the protocol described in the aforementioned '287 patent that was captured on a digital storage oscilloscope and used as an electrical stimulus in the present invention.

FIG. 5 is a drawing of the octamethylcyclo-tetrasiloxane molecule, which was the marginally soluble silsesquioxane that provided a host for lithium guest ions in the reaction reported in U.S. patent application 2013/0233718.

FIG. 6 is a drawing focusing on the internal silicon-oxygen cage structure of the polyhedral silsesquioxane molecule, which is the soluble silsesquioxane that provided a host for lithium guest ions in the method described in the current application.

FIG. 7 is a datalog for a first experiment using palladium electrodes in a solution and being stimulated in accord with the method of the present invention; it is representative of this and several other experiments.

FIG. 8 is a datalog for a second experiment using palladium electrodes in a solution and being stimulated in accord with the method of the present invention that focuses on one particular heat spike that was captured with both thermocouples and a pressure transducer.

FIG. 9 is a datalog for a third experiment using palladium electrodes in a solution and being stimulated in accord with the method of the present invention that shows evidence (radiation emission) that the reaction may be nuclear in nature.

FIG. 10 is a datalog for a fourth experiment using palladium electrodes in a solution that contained an increased amount of PSS and being stimulated in accord with the method of the present invention that shows an unusually strong reaction measured by both thermocouples and a pressure transducer.

FIG. 11 is a datalog for a fifth experiment similar to the one above using palladium electrodes in a solution that contained an increased amount of PSS and being stimulated in accord with the method of the present invention. In this experiment, the pressure was slightly reduced by deliberately and manually opening an outlet valve, which initiated an increase in temperature.

### DETAILED DESCRIPTION OF THE DRAWINGS

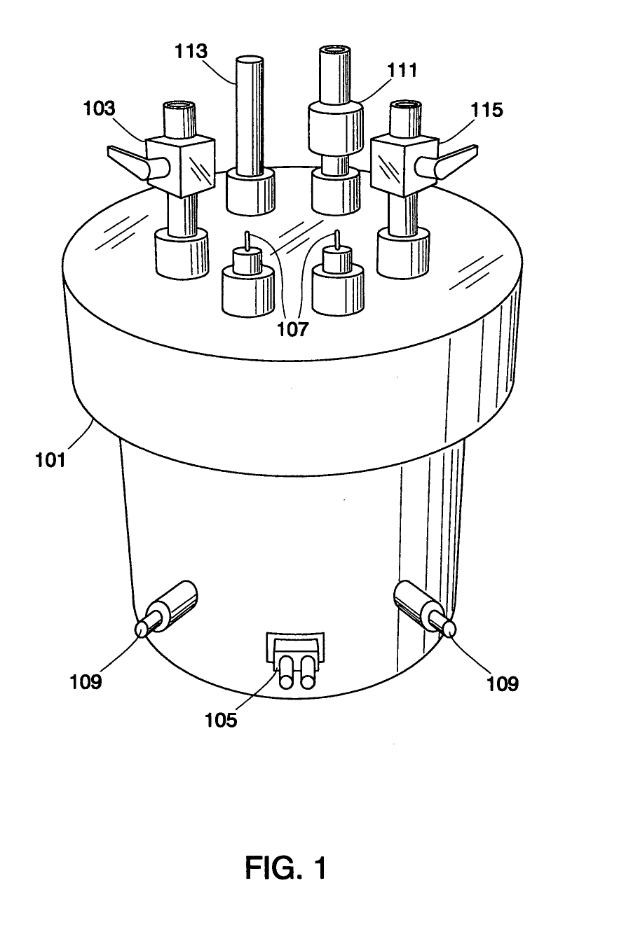

FIG. 1 shows the container [101] from a ¾ side, external, view. A liquid solution (not shown in this Figure) or its constituent solute and solvent(s) are placed into this container [101]. A gas inlet valve [103] can be used to admit a non-reactive gas to fill any open volume above the level of the solution, and thus blanket the solution. At the bottom of the container [101] is a heating element [105] that is used to bring the solution inside the container [101] to, and maintain it at, a temperature within 5° C. of the solution's current boiling point. At least two electrodes [107] are inserted into the container [101] with each electrode [107] far enough inside to be immersed in the solution when the method is in process. Spaced around the side(s) of the container [101] are photonic stimulating elements [109]; and electric stimulating means (not shown in this Figure) that attached to each electrode [107]. The container [101] also has a pressure relief valve [111], a temperature-measuring element [113] and, in the preferred embodiment, there is additionally an exhaust valve [115].

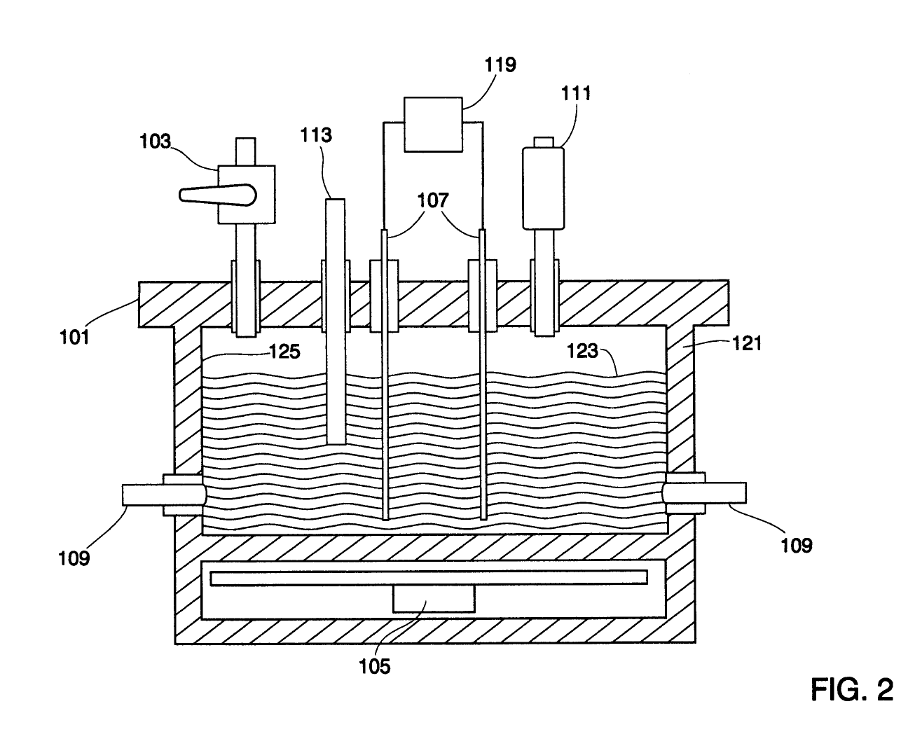

FIG. 2 shows the container [101] from a cut-through, side view with the heating element [105] at the bottom. At the top are the gas inlet valve [103], a relief valve [111] and temperature measuring element [113]. The container's sidewall [121] is of metal and thick enough to contain a liquid solution [123] under more than standard atmospheric pressure; the sidewall's interior surface [125] at and around any location where the stimulation will initiate exothermic reactions, is of glass or a siliceous substance, possibly a ceramic material. At least two electrodes [107] are attached to the electric stimulating means and immersed into the liquid solution [123]. Spaced around the sidewall [121] are the photonic stimulating elements [109].

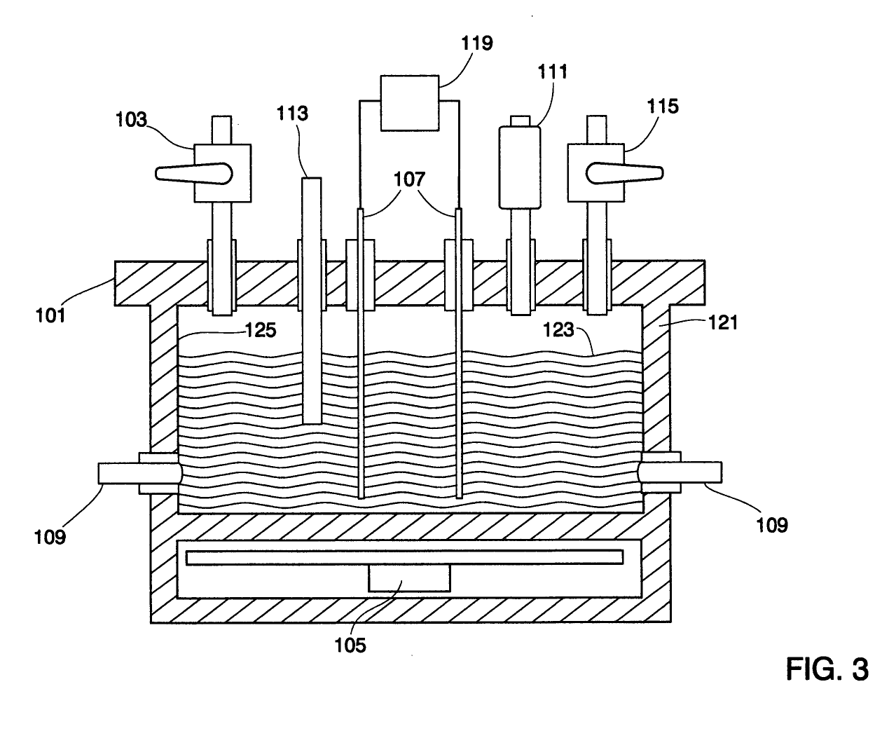

FIG. 3 shows the preferred embodiment of the container [101], where an exhaust valve [115] is placed in and through the container [101], enabling controlled release of the gases within the interior of the container [101].

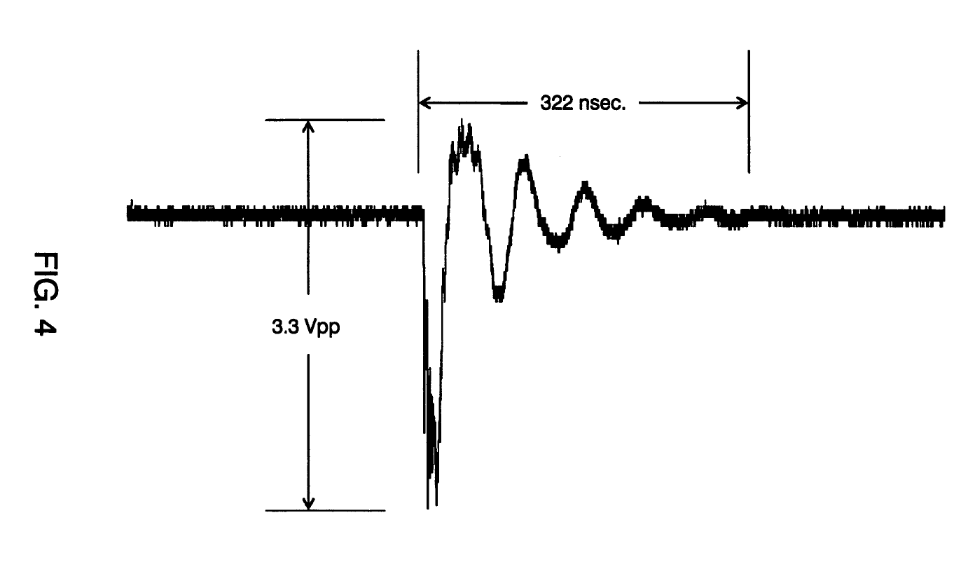

FIG. 4 shows a waveform with an intensity differential of 3.3 Vpp and a pulse duration of 322 nsec. emitted from within the container's interior during the application of this method.

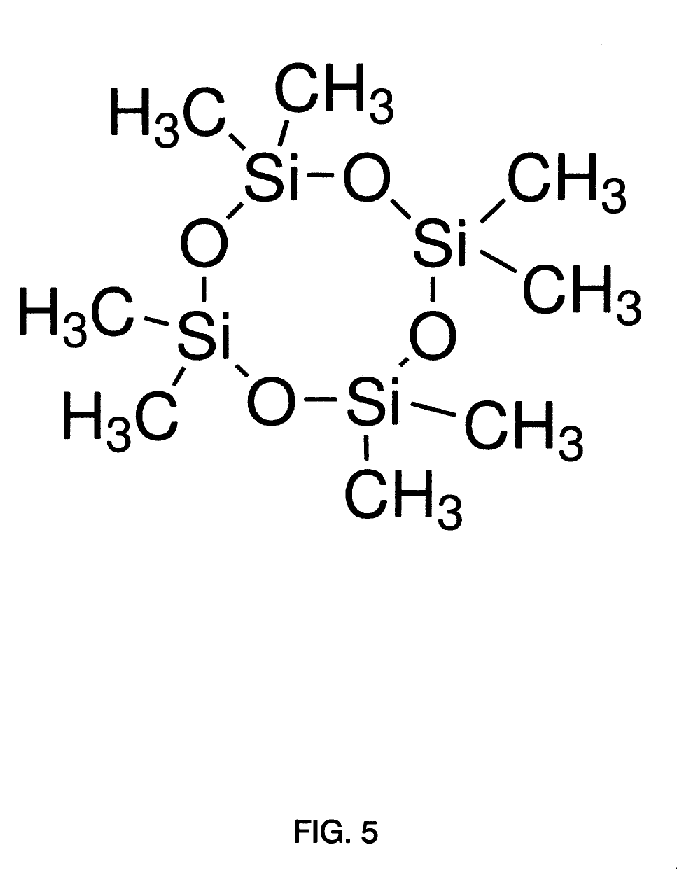

FIG. 5 is a drawing of the octamethylcyclo-tetrasiloxane molecule, which was the marginally soluble cyclosilsesquioxane that provided a host for lithium guest ions in the reaction reported in U.S. patent application 2013/0233718.

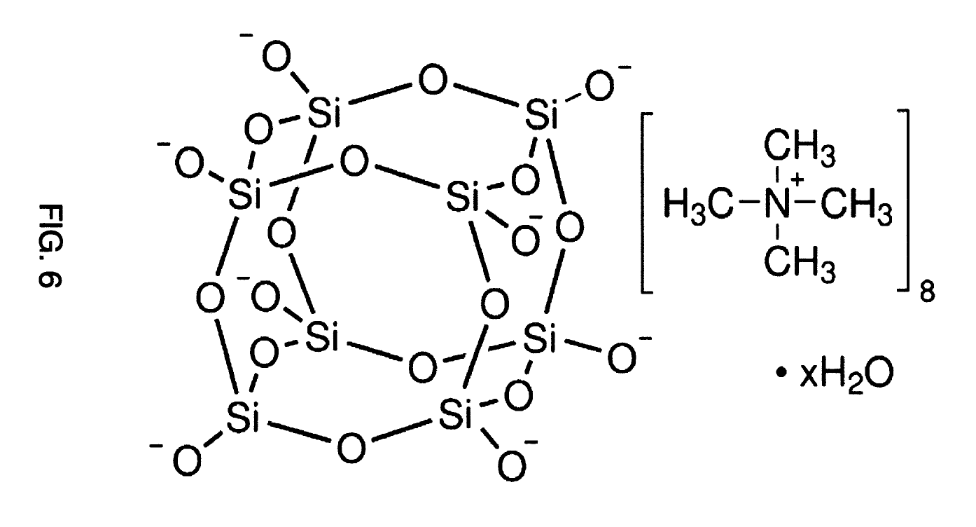

FIG. 6 is a drawing of the polyhedral silsesquioxane molecule, which is the soluble silsesquioxane that provided a host for lithium guest ions in the method described in the current application. The shape of the central ‘cage’ this molecule takes (again, within the inner ring of the oxygen (‘O’) and silicon (‘Si’) atoms), is more fully a three-dimensional form of two layers of rings of alternating silicon-and-oxygen atoms.

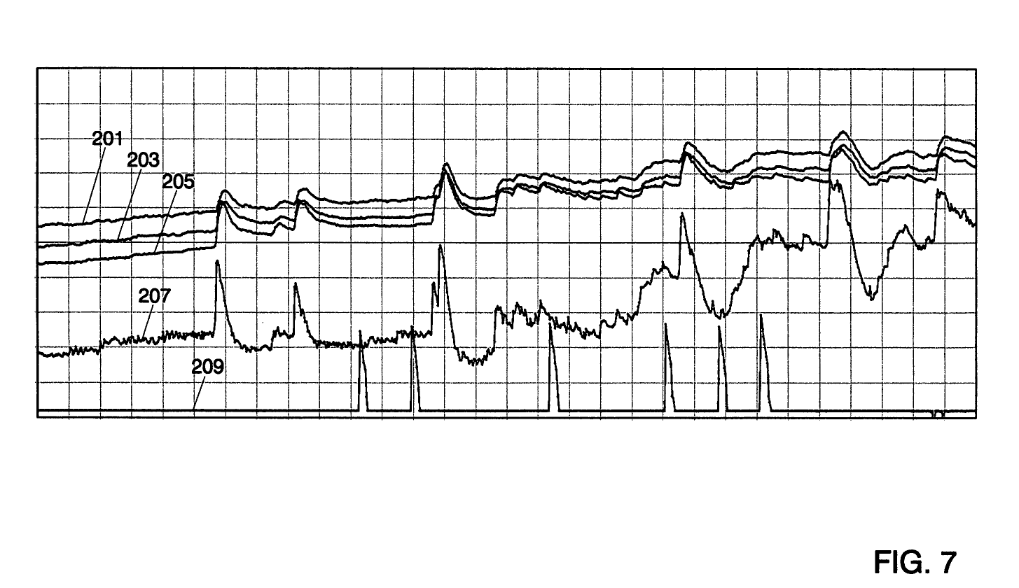

FIG. 7 is a drawing of results during the first experiment. This graphs the changes in temperature and pressure as the method is applied to the container [101] and solution [123], with values measured and shown for two separate measurements of the temperature of the solution (labelled ‘Solution 1’ [201] and ‘Solution 2’ [203] in this and the remaining Figures), the temperature the gaseous headspace [205], and the changes in pressure [207] inside the container; with concurrent measurements of with activity from the neighboring Bonner Sphere [209] indicative of radiation. This drawing shows concurrent temperature and pressure increases within the container [101] as the method is applied, with the concurrent major spikes in activity unrelated to the decreasing supply of heat (not shown, but observed and recorded) from the heating element [105]. The overall and correlated changes, not the precise moment-by-moment measurements, are significant.

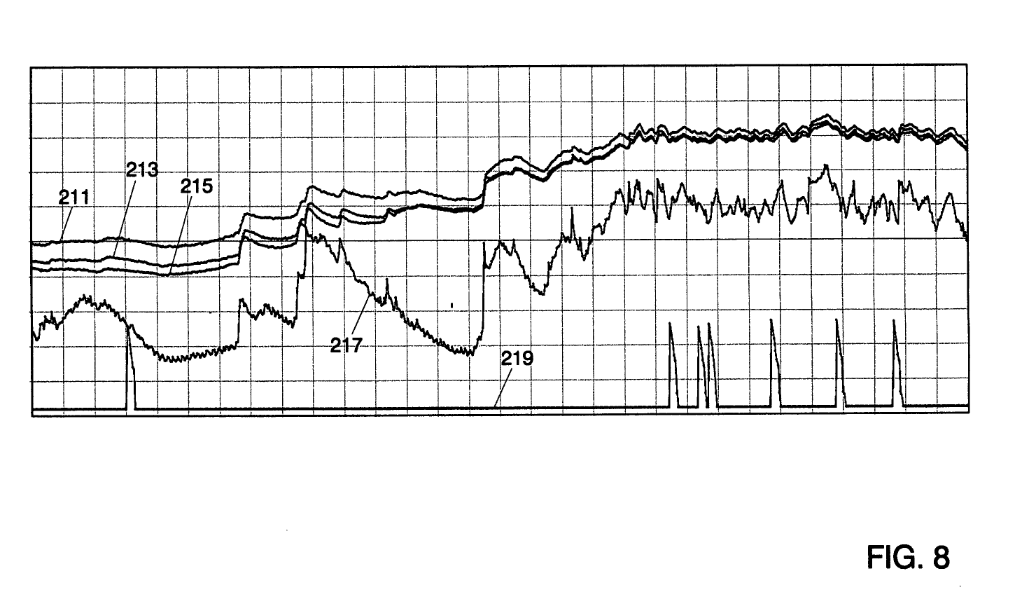

FIG. 8 is a drawing of results during the second experiment. This graphs the changes in temperature and pressure as the method is applied to the container [101] and solution [123], with values again measured and shown for two separate measurements of the temperature of the solution—Solution 1 [211] and Solution 2 [213]; the temperature of the gaseous headspace [215]; along with changes in pressure [217] inside the container, and with concurrent measurements of activity from the surrounding Bonner Sphere [219] indicative of radiation. This drawing shows mostly concurrent temperature and pressure increases within the container [101] (particularly as spikes occur in the temperature) as the method is applied. Again, it is the overall and correlated changes, not the precise moment-by-moment measurements, are significant.

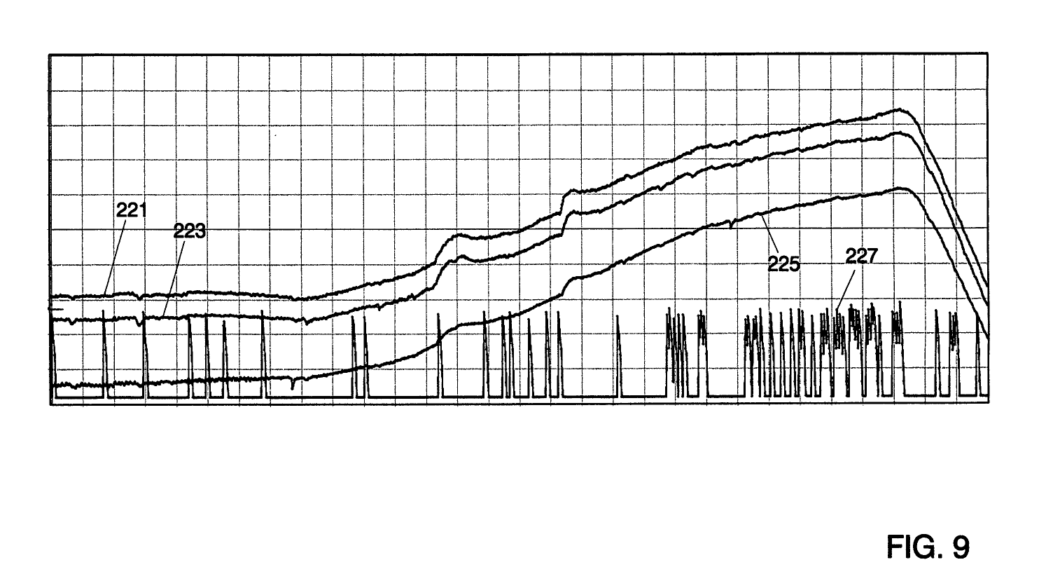

FIG. 9 is a drawing of results during the third experiment. This graphs the changes in temperature as the method is applied to the container [101] and solution [123], with values measured and shown for two separate measurements of the temperature of the solution—Solution 1 [221] and Solution 2 [223]; and the temperature of the gaseous headspace [225]; with concurrent measurements of activity from the surrounding Bonner Sphere [227].

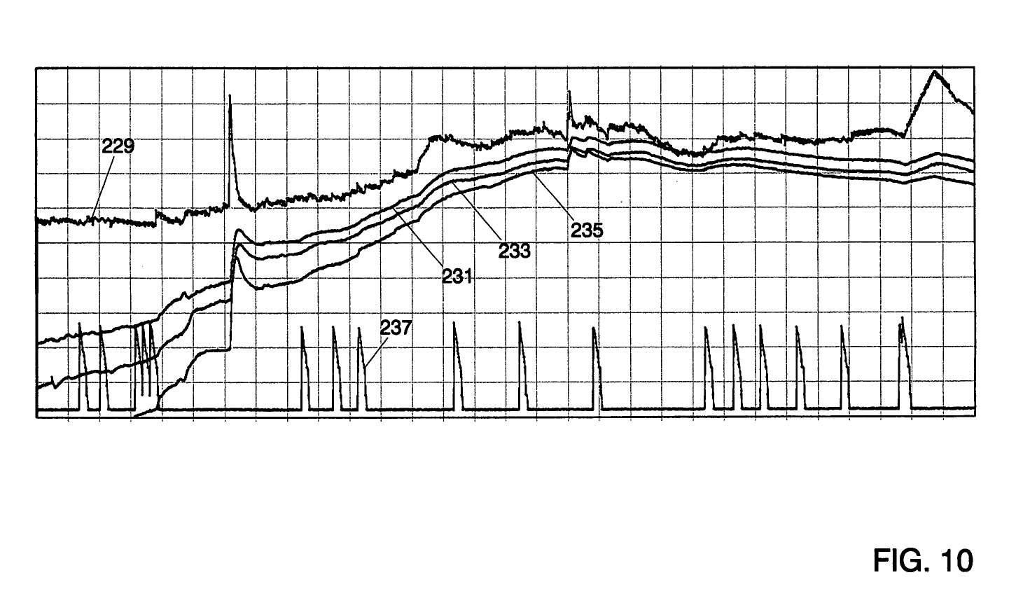

FIG. 10 is a drawing of results during the fourth experiment. This graphs the changes in temperature and pressure as the method is applied to the container [101] and solution [123], with values again measured and shown for two separate measurements of the temperature of the solution—Solution 1 [231] and Solution 2 [233]; and the temperature of the gaseous headspace [235]; with concurrent measurements of activity from the surrounding Bonner Sphere [237] and changes in pressure [229]. Of particular note are the two occurrences of major and concurrent spikes of both temperatures and pressure near the left and right sides of this graph, one apparently a release of energy as an impulse, the other as a ramp.

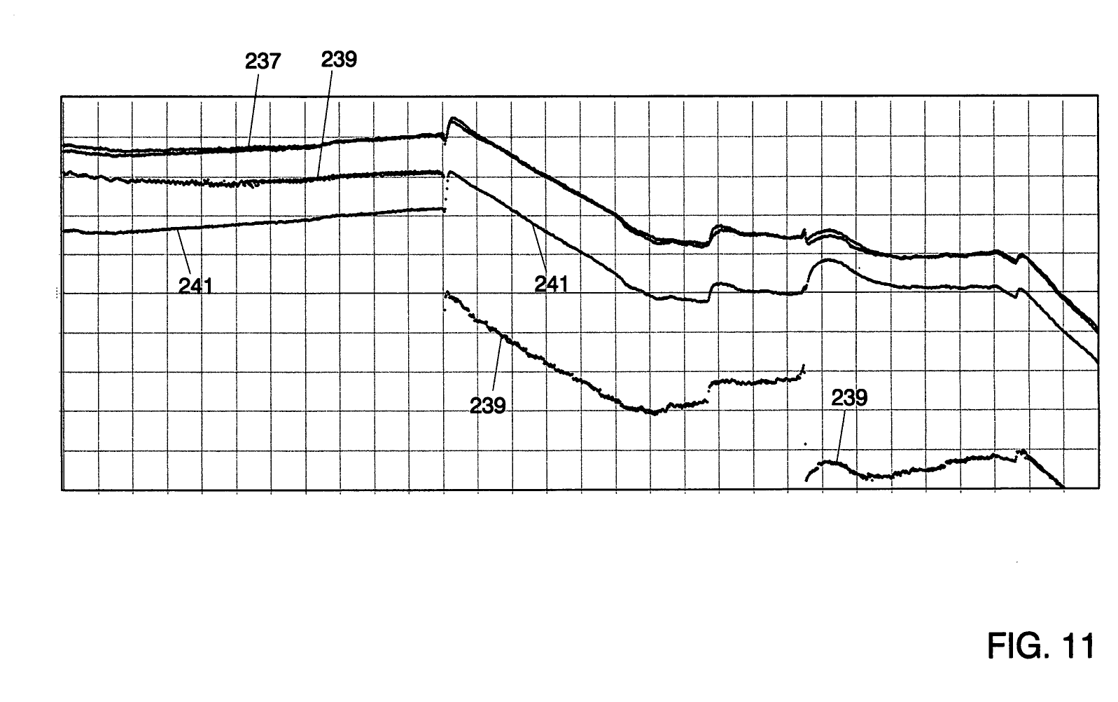

FIG. 11 is a drawing of results during the fifth experiment. This graphs the changes in temperature and pressure as the method is applied to the container [101] and solution [123]. In this experiment controlled releases of pressure were effected which initiated spiking changes in temperature and pressure sufficient to create apparent discontinuities in the graph (so the apparently-separated segments are labelled to indicate which segments should be connected). The values measured and shown for the temperature of the solution from two separate measurements were virtually identical and in this Figure are joined in labelling as being inadequately distinguishable [237]. The value measured and shown for the temperature of the gaseous headspace [241] unexpectedly increased dramatically when the first controlled release was made of the pressure [239]; with that drop in pressure also came a spiking in all of the temperatures [237, 241], though the second upward spike was not as dramatic. This drawing shows the concurrent presence of temperatures rising with a pressure drop, a counter-intuitive correlation that appears to contradict Boyle's Law.

### DETAILED DESCRIPTION

The treatment protocol in accord with the present invention involves, among other steps, heating a solution in a sealed reactor to within 5° C. of the solution's boiling point. Boiling point is the temperature for which the liquid solution's vapor pressure equals that of the pressure surrounding the liquid. Because this treatment protocol's heating of the solution takes place within a sealed vessel, this application defines “boiling point” when used without qualification to generically include a “standard pressure boiling point”, a “current pressure boiling point” and a “pressure release limited boiling point” of the solution. “Standard pressure boiling point” is defined as the solution's boiling point at a standard pressure of 100 kilopascals. “Current pressure boiling point” is the solution's boiling point assuming the reactor interior's pressure at any given moment. “Pressure relief limited boiling point” is the solution's boiling point at the maximum allowed pressure within the reactor as defined by one or more pressure relief valves or other pressure relief mechanisms that are included for safety. At a minimum, the temperature of the solution will be raised to within 5° C. of the standard pressure boiling point. However, as in a pressure cooker, the sealed vessel allows the solution to be further heated to even higher temperatures and maintained at any temperature from within 5° C. of the current pressure boiling point to one less than and not equal or exceeding, the pressure release limited boiling point (at which temperature and specified pressure the pressure relief valve or similar safety mechanism will open to partially relieve internal pressure within the reactor). It should also be noted that the reactor need not necessarily be perfectly sealed, in which case there could be some small amount of steam leakage around seals for the vessel's various access ports. The reader is also reminded that although the solution is a mixture of light and water, heavy water at standard pressure has a higher boiling point (101.4° C.) than ordinary water (100° C.), and inclusion of dissolved lithium sulfate and soluble polyhedral silsesquioxane in the solution raises the standard pressure boiling point even further.

The treatment protocol is performed in a sealed reactor that, in turn, is part of a system that includes equipment for generating electrical and light (photonic) stimuli, heating the reactor, and measuring and recording temperatures and pressure. The reactor includes an electrolytic cell consisting of two or more electrodes, composed of similar or dissimilar metals, for example of palladium, silver, platinum, or gold, or even conductive material other than metal. One or more of the electrodes have material surface(s) to be treated. At least one of the electrodes is in intimate contact with a source of siliceous material, and thus, for example, may be coated with silica or a silicate, threaded with silica or glass beads, or the electrode may consist of sintered metal and silica. The electrodes are immersed in a solution of an electrolyte in a liquid, such as a mixture of lithium sulfate (Li₂SO₄), and a soluble polyhedral silsesquioxane in a mixture of light water (H₂O) and heavy water (D₂O), which is an additional source of silica in the reaction. A pH-buffering agent, as used in the aforementioned '287 patent, was found to be optional. The optional buffering agent might comprise either EDTA, citric acid, sodium bicarbonate, or lithium hydroxide in quantities sufficient when needed to maintain a pH in a range from 6.5 to 8.9.

As before, the electrolytic cell may be of any size needed to accommodate a work piece whose surface is to be treated by this protocol. However, the reactor used in the present invention was the same one described in U.S. patent application Ser. No. 12/688,630 and the subsequent CIP, with three modifications: 1) an additional thermocouple was added to measure the temperature in the headspace above the liquid surface in the reactor, 2) a pressure transducer to record the pressure in the headspace was substituted for one of the relief valves, and 3) a silver gasket was used between the closed bottom of the reactor and its removable top.

Specifically, the reactor was a stainless steel cylinder with a central well 5.08 cm deep and 5.08 cm in diameter, having a closed bottom and a removable top. It was dimensioned to accommodate a glass beaker capped with a quartz top. The beaker's lip had been trimmed so it slid into the cylinder with a minimum gap between the metal and the glass. Alternatively, the reactor may be a glass- or silica-lined metallic reactor. The reactor could also be lined with a piezoelectric material, in the form, e.g., of a porcelain glaze. A sealed reactor prevented the escape of steam, along with other constituents in the solution or reaction products, or allowed only very slight escape of steam. It also allowed higher temperatures to be obtained under pressure for a given aqueous solution. Ports in the top allowed electrodes, thermocouples, and gases to pass through it, while sealed glass ports in the reactor sidewall allowed for the concurrent photonic stimulation by exterior illumination. The reactor weighed more than five kilograms, thereby providing considerable thermal mass to ensure that measured temperature transients were generated within the reactor and not the result of external impulses. As a safety practice appropriate when working with exothermic reactions in a sealed reactor at or near the boiling point of water, the reactor was equipped with one or two pressure relief valves set to lift at several PSI above one atmosphere.

The liquid within the reactor was blanketed during the experiments with helium gas to allow the saturation of the liquid with that gas. The atmosphere was vented through an outlet valve while that gas was being introduced into the reactor via another valve. The valves were ball valves made by Swagelok® that allowed for very slight release of gas. The saturation of the liquid with this gas is optional.

A heating coil was located in a cavity in the bottom of the reactor, and its input voltage and current could be measured to monitor input power. The temperature of the reactor was raised to approximately 100° C. while the electrical and photonic stimuli were applied. A pair of thermocouples monitored the temperature of the liquid via glass thermocouple wells projecting into the liquid and a third monitored the temperature in the headspace via a similar well.

It has been determined through experimentation using the various silicates identified in the previous patent and patent applications that the desired exothermic reaction has a characteristic and readily identifiable temperature response in the reactor. No attempt was made to make calorimetric measurements due to the difficulty of making such measurements near the phase change of a boiling liquid; the temperature transients and concurrent increases in pressure were judged to be sufficient evidence of heat generation.

Two electrodes were immersed in the liquid. More electrodes are optional. The work piece or pieces to be treated are used as one or more of these electrodes, which can be of any shape and size. The material being surface treated by this method may be a conductive material such as a solid metal or alloy, containing for example palladium, or may be metallically plated with the desired surface material. Since at least one is in intimate contact with a source of siliceous material when the stimuli are applied, any of the electrodes may also be surface coated with other materials, such as silicates.

Electrical and photonic stimuli were applied in manner similar to that previously described in the earlier patent and patent applications. The electrical stimuli were provided via two or more parallel palladium electrodes of 0.063 mm diameter: a cathode and an anode for the AC stimulus and an optional second anode for a DC stimulus (the optional DC stimulus generated with a DC power supply). The electrical stimulation may, however, consist of either or both an AC voltage and a DC voltage, where the AC voltage can be modulated with frequencies in the RF range, possibly including frequencies that coincide with absorptive spectra of components of the solution. The electrical stimulation may be a combination of direct current voltage and alternating current voltage applied, either concurrently or sequentially, between either separate anodes and a common cathode, or a common anode and a cathode. In the present invention, the AC stimulus consisted of the emitted signal shown in FIG. 4 that had previously been captured. The electrical stimulating means can be any known in the present art; and that electrical stimulus will be discussed in more detail below.

The electrodes and the thermocouples were equally spaced in five holes on a bolt circle, so the anodes would be 2.3 and 3.7 cm away from the cathode. Similarly, the thermocouples would be 2.3 and 3.7 cm away from the cathode. Both the electrodes and the thermocouples passed through the reactor's top via Teflon® seals compressed with Swagelok® fittings.

Four “Ultrabright” white light-emitting diodes (LEDs) capable of generating 15,000 mcd were spaced equally around the reactor below the surface of the liquid as photonic stimuli. These stimuli were provided through sealed glass ports in the reactor wall. The LEDs are pulse-modulated between their on and off states during the same period when the electrical stimulation is applied. Electrical and photonic stimulation may be applied either concurrently or sequentially, although concurrently is preferred.

When only the AC stimulus was used, the word “cathode” is used to describe the grounded side of the AC signal.

Additionally, the solution contained a form of silica. In the present and improved embodiment of the invention, the silica is a soluble silsesquioxane called “Polyhedral Silsesquioxane hydrate-Octakis (tetramethyl-ammonium) substituted”. It is manufactured by Hybrid Plastics in Hattiesburg, Miss., and has the product name “Octa TMA POSS®”, the product number MS0860, and the CAS number 69667-29-4. Hybrid Plastics defines their product as being “a hybrid molecule with an inorganic silsesquioxane at the core and anionic oxygen and a tetramethyl ammonium ion at the corners of the cage”. This chemical is also distributed by Sigma Aldrich with the part number 522260 and is labeled as having 98% purity. Interestingly, Sigma Aldrich calls this class of chemicals “Polyhedral Silsesquioxanes”, while Hybrid Plastics identifies them as “Polyhedral Oligomeric Silsesquioxanes” and has trademarked the acronym POSS®. In this application, the terms are used synonymously.

Polyhedral Silsesquioxane hydrate-Octakis (tetramethyl-ammonium) substituted is not a surfactant. This was determined by measuring the number of drops of distilled water and the number of drops of a 0.20 molarity solution of Octa TMA POSS® needed to fill a given volume and applying the formula σ=σ_{H2O}*(m/m_{H2O}), where m_{H2O} is the mass of a single drop of water and m is the mass of a single drop of the POSS solution. The measured surface tension of the POSS solution was 125 mN/m, compared to 73 mN/m for water. The molarity of the solution was calculated using the anhydrous molecular weight provided on the Sigma Aldrich website for PSS.

The protocols previously identified had various gestation periods before the exothermic reaction was observed. For instance, when using anionic silica hydride as detailed in U.S. Pat. No. '287, the reaction required at least two hours, and sometimes as many as eight hours, of treatment before bursts of heat were observed. When using the siloxane as detailed in application Ser. No. 12/688,630, the reaction required as many as thirty hours in intervals extending over as many as four days before the reaction was observed. Further, the reaction occurred in only half of the cyclosiloxane experiments, while it occurred in almost all of those with anionic silica hydride. In the present invention, the reaction was observed in one experiment as the temperature approached within a few degrees of the boiling point of the liquid. The reaction was thus more temperature-dependent than time-dependent in that instance, and the gestation period was found to be measured in minutes, if there was any gestation at all upon reaching temperatures at or near the boiling point.

As reported in the earlier patent and patent applications, it is suspected that something must be happening to either the solution or to the electrodes in that gestation period to facilitate the observed reaction. Lithium salts, such as lithium sulfate (Li₂SO₄), are used as an electrolyte in the solution. Since the reactions in the earlier protocols do not occur immediately, it is believed that the silica and the lithium in those protocols are bonding in some way before the bursts of heat are observed. In particular, the lithium may be combining with the silica compound in the solution over the time frame of the treatment protocol to form a lithium silicate.

Other experimenters in this field have found that successful LENR reactions can occur when sodium cations are substituted for lithium cations, although none of the experiments reported herein used a sodium salt.

When cage silsesquioxanes were used as a source of the silica, as when anionic silica hydride was used for the experiments reported in U.S. Pat. No. '287, the lithium could either be bonding to an apex of the siliceous cage structures or entering the interior of the silica cage host as a guest. Given the results of subsequent experiments with other silicates, it is now believed that the lithium ion entered the anionic silica hydride cage as a guest.

Octamethylcyclotetrasiloxane was used in the aforementioned U.S. patent application '718. It has a silica ring structure of four silicon atoms alternating with four oxygen atoms, as shown in FIG. 5. It is known that lithium ions bond as guests within the ring of the octamethylcyclotetrasiloxane host, entering and leaving the center of the ring in a dynamic process that reaches a stochastic equilibrium over time. Note that the molecule has methyl radicals, which are hydrophobic and therefore account for its low solubility.

The polyhedral silsesquioxane (PSS) used in the present method is shown in FIG. 6. It has some attributes of both a cyclosiloxane ring and of a silsesquioxane cage structure. Specifically, it consists of two silica rings with four silicon and four oxygen atoms each. The rings are coplanar, and the radicals bound to them are tetramethylammonium, which is hydrophilic, thereby making the molecule soluble. In a telephone conversation with the product development manager of Hybrid Plastics, he pointed out that the distinguishing attribute of the POSS molecule is that its silicon atoms form a cube that is rigid and has completely defined dimension (0.53 nm) with eight organic groups at the vertexes of the cube.

One can visualize that a lithium ion could enter the POSS molecule as a guest, much as it could the cyclosiloxane ring. The fact that the organic groups extend out from the center of the cube allows a guest such as the lithium ion easier access to host than a more complex geometry might allow.

Due to the coplanar geometry, the ion would bond more strongly to the two rings than to a single one as in a cylcosiloxane, and, once in the center, would be held between them by the tension of bonding in opposing directions by both of them. It would appear, then, that this coplanar rings host would be a more stable one than a single ring, thus extending the lithium ion's status as a guest and increasing the percentage of PSS molecules hosting lithium ion guests at any given time. That may account for the lower gestation period in the current method.

It has been found that the treatment works better when some RF frequencies are used as electrical stimuli than others and that the protocol yielded heat bursts in the sealed reactor in more or less time when different frequencies were used as stimuli. Given how important the presence of silica is to the effectiveness of the treatment protocol, it is speculated that certain natural frequencies of vibration of the silica bonds in the solution are being driven to vibrational resonance by the RF electrical stimuli, the photonic stimuli, or both. As a general statement, resonance is the tendency of a system or phenomena to oscillate at larger amplitude at some frequencies than others. Such systems and phenomena absorb energy at these resonant frequencies, such that stimulating a system or a phenomena at a resonant frequency or set of resonant frequencies can cause the underlying oscillation to amplify, often dramatically so.

That suggests that a signal emitted by the reaction could then be reapplied as a stimulus. FIG. 4 shows a .tif image of an oscilloscope trace of such a signal captured by an Agilent model DSO5054A high-speed digitizing storage oscilloscope during an earlier experiment. This waveform begins with a negative spike that is fairly complex and then becomes a decaying sinusoid. The signal was also captured as a digitized file that can be used as in input to an AWG (Arbitrary Waveform Generator). The resultant signal repeated with a period of 322 nsec. The FFT function of the oscilloscope showed the waveform to have a fundamental frequency of approximately 2.6 MHz and a second harmonic of 5.2 MHz. The spectrum of the signal also had higher frequency components, but they did not have the regular order of a Fourier presentation. This waveform, used as the electrical stimulus, was observed to yield results at least as good as the stimuli in the methods reported in the earlier '287 patent and the pending patent applications.

Through experimentation, it was determined that a light source of white LEDs were preferred to stimulate the reaction. Red and blue LEDs were used and proved not to be effective. It may be significant that white LEDs generate light at three wavelengths.

The Specific Steps of the Protocol Using Polyhedral Silsesquioxane are Shown Below:

Step 1. Prepare a solution by first combining, as a solvent, 15 ml of heavy water (D₂O) to 15 ml of light water (H₂O) in an open beaker. Add an electrolyte of 1.650 gm of Lithium Sulfate Monohydrate (Li₂SO₄.H₂O). Another lithium salt could be used. Add 0.020 gm of polyhedral silsesquioxane hydrate-octakis (tetramethylammonium) substituted. (The amount of PSS was increased to 0.110 gm in a single experiment to test whether the reaction would increase with the higher concentration of that substance.) Heat for twenty minutes to a temperature between 90° C. and 95° C. After heating, optionally, buffer the solution with citric acid until it has a pH in the range of 6.9 to 8.3.

Step 2. Transfer the solution from the open beaker to the reactor. Install the electrodes in the reactor. Seal the reactor and introduce a blanket of helium gas above the solution to create saturation with that gas in the liquid and to maintain such saturation for the duration of the protocol. Then heat the solution to bring it to a temperature between 100° C. and 103° C.

Step 3. Then treat the surface of the electrodes with the following process: Stimulate electrodes immersed in the liquid with a time-varying electrical voltage. The electrical stimulation may again preferably consist of the captured signal shown in FIG. 4 with an amplitude of 3.3 Volts when driven from a 50-ohm output. This stimulation was generated with an Agilent 33250A arbitrary waveform generator. Again, simultaneously photonically stimulate the electrodes and the gap between them using, e.g., the four LEDs capable of 15,000 mcd each through the ports in the reactor wall described above, spaced around the sides and aimed at the center. The LEDs are preferably pulse-modulated by frequency-hopping through the following six frequencies, dwelling at each for five minutes: 464, 1234, 1289, 2008, 3176, and 5000 Hz with 50% duty cycles. The four LEDs were powered in parallel with 12.5 Volts and drew 0.02 amps each, averaged over the pulse modulation. Continue stimulating concurrently with both electrical and photonic stimuli at an elevated temperature within 2° C. of the boiling point. Monitor the input power, thermocouples, and pressure within the reactor with a datalogger. The surface treatment protocol should last at least for a duration that provides some specified minimum number of heat bursts of approximately 1° C., e.g., at least four such bursts, or until a sustained exothermic reaction is established.

Step 4. An optional fourth step was used in one experiment. For some reason, the solution reached a temperature several degrees above the boiling point. An exhaust valve was deliberately and manually opened while it was at that elevated temperature. Steam had condensed on the inner surface of the headspace. A single steam bubble formed at the outlet of the exhaust valve and then burst. The resulting drop in pressure within the reactor initiated an exothermic reaction. The step was repeated several minutes later, with a similar result.

Three things appear to inhibit the reaction in all of the protocols reported above: rubber, Teflon®, and ultra-pure palladium, e.g. palladium with a purity of 99.999% (collectively and individually, these are ‘inhibiting substances’). While Teflon® was used to seal the lights and electrodes, care was taken to trim it so as to minimize the surface area exposed inside the reactor.

Here are some representative results from experiments:

Experiment 1
The electrodes for this experiment were palladium. They were placed in the 50/50 solution of light and heavy water with the lithium sulfate electrolyte and polyhedral silsesquioxane, as described above. The time-varying electrical stimulus was the captured emitted signal, also described above.
The datalogs are shown in FIG. 7. Six distinct bursts of energy can be seen in the datalog. Note that each of them is accompanied by a concurrent increase in pressure in the headspace and that the energy transient is consistently faster on the pressure transducer than on the thermocouples. (The thermocouples in all experiments reported in this application were shielded, and therefore had greater thermal mass and lower response times than those used in the aforementioned '267 patent and the pending patent applications.)
A DC stimulus was applied with the RF stimulus because the RF signal was reduced by the low impedance of the solution to the degree that it would not be expected to overcome the Coulomb barrier on the electrodes. Its voltage and current remain constant throughout the interval shown on the datalog.
A Bonner sphere is a detector capable of detecting various forms of radiation, including neutrons, gamma rays, and cosmic rays. Note that the recorder output from the Bonner sphere is shown at the bottom of the figure, and there is no perceptible correlation to the energy transients. The six events logged by the Bonner sphere are fairly typical of the background radiation it detects on an ongoing basis. There is not enough information to determine the type of radiation, but they are probably either cosmic rays or gamma rays.

Experiment 2
The setup for this experiment was the same as the one described for the first experiment detailed above.
The datalogs are shown in FIG. 8. Note the sharp increase in pressure logged in the center of the graph.
Note also that the recorder output from the Bonner sphere is shown at the bottom of the figure, and again there is no perceptible correlation to the energy transients. If anything is unusual about the output logged from the Bonner sphere, it is the unusually long period of inactivity for the first 26 minutes.

Experiment 3
The setup for this experiment was the same as the one described for the first and second experiments detailed above, except that a pressure transducer was not used in this experiment.
The datalogs are shown in FIG. 9. Note that the thermocouples captured only two relatively modest heat transients and that they were not correlated to an increase in activity detected by the Bonner sphere.
However, note also that after the temperature recorded by both thermocouples in the solution in the reactor passed through 103° C., there was an increase in events captured by the Bonner sphere. The increased rate persisted for 32 minutes until input power to the reactor was secured and the temperatures dropped back below the boiling point. There were 38 events captured in that interval, compared to eight captured in the previous 32 minutes. That's approximately 4.75 times greater than the more normal background radiation of the earlier period.

Experiment 4
The setup for this experiment was the same as the one described for the first and second experiments detailed above, except that the amount of PSS was increased 5X over those experiments to 0.110 grams. The amount of PSS was increased to determine whether the reaction would also increase with the higher concentration.
The datalog is shown in FIG. 10. Note the sharp increase in pressure logged in the right half of the graph. This increase is substantially larger than that logged in Experiment 2.
Note also that the recorder output from the Bonner sphere is shown at the bottom of the figure, and again there is no perceptible correlation to the energy transients.
The conclusion from this experiment is that there is a positive relationship between the concentration of the PSS and the resulting reaction, although safety considerations prohibited a test for an upper limit.

Experiment 5
The setup for this experiment was the same as the fourth experiment above. The datalog for this experiment is shown in FIG. 11. The centerline for the temperatures recorded by thermocouples in the solution and the headspace is 108° C. The data was being scanned every 2.5 seconds.
Curiously, the temperature of the solution rose as high as 112° C. without any reaction. An exhaust valve was deliberately and manually opened slightly to allow a very small release of gas and thus a reduction in pressure while the stimuli were being applied. Note that the datalog captures the expected reduction in pressure, as described above. Note also that the temperatures in both the liquid and the headspace drop for a few seconds, and then rise with the characteristic thermal signature of the desired reaction.
The exhaust valve was opened a second time approximately ten minutes later, and the behavior repeated: pressure dropped and temperature rose.

The third experiment is obviously of particular interest because of the unusual level of radiation detected. It differed from the other two described above in some important respects:
This experiment was held at a temperature below the boiling point for four hours, and then raised above the boiling point. In the other experiments, the temperature was raised directly to the boiling point.
After the experiment, the reactor was found to have lost no liquid, or virtually no liquid, during the experiment. More typically, the reactor loses about 30% of the liquid during an experiment.
It is possible that the dominant reaction pathway in the experiments not showing evidence of increased radiation is a pathway that yields heat, but does not yield such radiation. However, the absence of leaks and pressure drops may force the reaction down an alternate pathway that does yield such products.

In the aforementioned U.S. patent application publications, a possible model for the reaction detected in experiments was suggested where a slight leak might have momentarily lowered the pressure within the reactor and allowed steam bubbles to form on an electrode. Those bubbles might be the site of the reaction, and the heat from an initial spark of such a reaction could cause a cascading reaction, which would quench when the reactor regained its seal. Others attempting to reproduce the observed results were alerted to the possibility the reaction occurs at the phase change interface of water and steam and to try experiments with and without a very slight leakage.

The fact that temperature spikes were muted in the third experiment above when little or no liquid was loss seems to support that reasoning. The fact that the temperature rose when the pressure dropped in the fifth experiment provides even stronger support for that reasoning. Gay-Lussac's law states that the pressure exerted on the sides of a container by an ideal gas of fixed volume is proportional to its temperature; when temperature rises, so should pressure. The datalogs for experiment five do the opposite and, thus, violate the law. The only plausible explanation for the contrary behavior is that the drop in pressure is initiating an exothermic reaction that raises temperature enough to overcome the drop required by Gay-Lussac's law.

A glass beaker was used in experiment 5. After the experiment, visual examination found (and a photograph showed) a deposit on the inside of the beaker that resembled a precipitate, extending approximately 2 mm from the beaker wall towards the center of the beaker. However, precipitates fall to the bottom of a solution; they don't transport laterally. The lateral deposition suggests that the deposit was caused by some extreme, local heat.

Taken together, the experiments conducted with anionic silica hydride, cyclosiloxane, and polyhedral silsesquioxane support the reasoning that silica is critical to the reaction and that a lithium silicate in which a lithium ion is bound as a guest in a silica host promotes a stronger reaction. At the present state of the research in LENRs, it is not known whether the lithium silicate is a reactant, in which case it would be consumed in the reaction, or a catalyst, in which case it would not be consumed. The consumption of a reactant in a nuclear reaction would be so small it would not be detectable in these experiments.

After numerous experiments in both open beakers and the closed reactor, conducted using the protocols reported in the aforementioned '267 patent and patent application publications, and this application, there has been no evidence whatsoever that the exothermic reaction observed takes place spontaneously anywhere other than within 5° C. of the current boiling point of the liquid solution; that is, 5° C. below or above that point. (Except in Experiment 5, where the initiation was effected deliberately by pressure release when the temperature of the solution was between a range from 5° C. below and 20° C. above said solution's current boiling point.)

### Preferred Embodiment of the Invention

Analysis of all the experiments summarized above yields a preferred embodiment of the invention, by which a desired exothermic reaction can be effected using an aqueous liquid in a system having at least two conductive electrodes but no inhibiting substances in contact with said aqueous liquid, as described in the following paragraphs.

The liquid solution is prepared by first combining equal amounts of heavy water and light water to form a solvent. To this is added an electrolyte (a first solute) including Group I element ions capable of being hosted in a hosting siliceous element whose molecular structure provides any of a silicon-oxygen cage and/or ring. In the preferred embodiment, 1.650 gm of Lithium Sulphate Monohydrate (Li₂SO₄.H₂O) is added as an electrolyte and first solute to 30 ml of solvent. Next a soluble hosting siliceous element whose molecular structure provides any of a silicon-oxygen cage and/or ring (a second solute) (0.020 gm of polyhedral silsesquioxane hydrate-octakis (tetramethylammonium) substituted to the above proportions) is added to the solvent and first solute. In alternative embodiments the electrolyte and first solute may be formed of a Group I (alkali) metal (lithium, sodium, potassium, caesium, rubidium). Stirring these additions is not needed as the subsequent heating dissolves the solutes. The first and second solutes may be already joined before being added to the solution, or the solution may be added to one, the other, or both together.

Either the solution is prepared within the system or once prepared is transferred into the system, until the at least two conductive electrodes are immersed at least partly, such that some or even all of their conductive surfaces are at least in contact with or entirely within said solution.

In the preferred embodiment of the invention, the principle structural element of the system will comprise a container with metal walls (in the preferred embodiment, steel) capable of retaining the solution under above-boiling-point pressure and temperature.

As noted above, the interior surface of the container must not include or incorporate either rubber or Teflon® (‘inhibiting substances’), particularly where the solution will be in continuous contact. Although under general understanding of current chemical or molecular theory these are ‘neutral’ and ‘non-affecting’ compositions, experimental data from independent and separate sources has established that the presence of these inhibiting substances within the interior of a system and in contact with the solution, severely and adversely inhibits the initiation of the desired exothermic reactions. Furthermore, although electrical stimulation is used, no, repeat no, electrode should be of ultra-pure palladium, i.e., palladium with a purity of 99.999% (another ‘inhibiting substance’)—even though such an electrode is a naturally conductive metal.

Also, the container's interior surface at and around any location where the stimulation will initiate exothermic reactions, is of glass or a siliceous substance. To the extent there must be any opening (for the means of providing stimuli, measuring the current physical condition(s) of the solution, or altering its temperature or pressure), intrusions and seals should be minimized and only minimally expose the solution to any of the inhibiting substances named above. In an alternative embodiment the container's interior surface could also be lined with a piezoelectric material, in the form, e.g., of a porcelain glaze. Thus, the container will comprise an interior whose sidewall's interior surface at and around any location where the stimulation will initiate exothermic reactions is comprised of any of the set of glass or siliceous substances, and whose interior surface does not have at any location that will be in contact with the solution any inhibiting substance.

The container will also comprise means for heating the solution when it is in the container; means for electrically stimulating the at least two electrodes connected to said electrodes; means for photonically stimulating the solution; and, means for releasing the pressure inside the container before it is damaged.

Next, the solution may be heated for twenty minutes to reach a temperature between 90° C. and 95° C. Before sealing the container, optionally the solution is buffered with citric acid until it has a pH in between a range of 6.9 and 8.3. This heating will dissolve the solutes.

Once prepared, the solution is transferred into or present in the container, in which at least two electrodes (not of ultra-pure palladium) are either already present or are installed such that they extend through the container and are partially immersed within the solution. The container is sealed and a blanket of helium gas is introduced into any airspace remaining above the solution to saturate the solution with that gas which is maintained for the duration of operation of the method. It is also possible to prepare the solution in the container directly.

Then the solution is heated to bring it to a temperature between 100° C. and 103° C.; in the preferred embodiment, that is to just above its current boiling point; and the system used a heating element to maintain the solution at a temperature between a range from 5° C. below and 5° C. above said solution's current boiling point.

Having prepared the container and the solution, transferred the prepared solution into the container and sealed the container, blanketed the solution with helium gas, and heated the solution to just above its current boiling point, next the solution and at least a pair of electrodes immersed in the solution are stimulated electrically and photonically. The photonic and electrical stimuli are applied concurrently.

The electrical stimulation comprises a time-varying electrical signal (in the preferred embodiment this will consist of the captured signal shown in FIG. 2 with an amplitude of 3.3 Volts when driven from a 50-ohm output). This signal as a voltage can be generated with an Agilent 33250A arbitrary waveform generator connected to the electrodes and made a part of the system. The photonic stimulation occurs simultaneously for both the electrodes and the solution in which they are immersed, using, in the preferred embodiment, four LEDs capable of 15,000 mcd shining each through its separate port in the container wall. These LEDs are preferably pulse-modulated by frequency-hopping through the following six frequencies, dwelling at each for five minutes: 464, 1234, 1289, 2008, 3176, and 5000 Hz with 50% duty cycles. These LEDs can be powered in parallel with 12.5 Volts (and will draw 0.02 amps each), averaged over the pulse modulation. Continue repeatedly stimulating the solution and electrodes, preferentially concurrently, with both electrical and photonic stimuli at an elevated temperature within 2° C. of the boiling point.

In the preferred embodiment sensors in the container will enable a user to monitor the input power, temperatures (via thermocouples), and pressure within the system, and the system will also employ a datalogger.

Once the temperature of the solution exceeds the current pressure boiling point and the (preferably) concurrent stimulation has commenced, that is, after the temperature of the solution exceeds the current pressure boiling point and before the temperature exceeds the pressure release limited boiling point, a fraction of the pressure inside the system is controllably released. This release can be effected manually, mechanically, or electronically using the pressure exhaust valve as the means for releasing the pressure inside the container. In the preferred embodiment its duration is of 5 seconds or less, even 2 seconds or less, effects a reduction of 30% or less of the pressure as of the start of the release, and reduces the temperature until that is within 10° C. of the solution's current boiling point. This transient pressure release is effected to cause a phase change in the solution, and drop the pressure of the solution to the standard pressure boiling point.

After any transient pressure release additional heat is provided to the solution to return it to and above the current pressure boiling point.

These post-stimulation-start steps are repeated for a duration that (a) provides a pre-specified minimum number of heat bursts of approximately 1° C., (e.g., at least four such bursts), (b) until a sustained exothermic reaction is established, (c) the solution is reduced to a level that no longer covers the electrodes; or (d) a predetermined time lapse (e.g. sixteen hours) has occurred without any heat burst(s) being observed.

The above description of the invention is illustrative and not restrictive. Many variations of the invention may become apparent to those of skill in the art upon review of this disclosure. The scope of the invention should, therefore, be determined not with reference to the above description, but instead should be determined with reference to the appended claims along with their full scope of equivalents.

While the present invention has been described in connection with at least one preferred embodiment, these descriptions are not intended to limit the scope of the invention to the particular forms (whether elements of any device or architecture, or steps of any method) set forth herein. It will be further understood that the elements, or steps in methods, of the invention are not necessarily limited to the discrete elements or steps, or the precise connectivity of the elements or order of the steps described, particularly where elements or steps which are part of the prior art are not referenced (and are not claimed). To the contrary, the present descriptions are intended to cover such alternatives, modifications, and equivalents as may be included within the spirit and scope of the invention as defined by the appended claims and otherwise appreciated by one of ordinary skill in the art.

I claim:

1. A method of initiating a desired exothermic reaction, using an aqueous liquid in a system having at least two conductive electrodes but no inhibiting substances in contact with said aqueous liquid, said method comprising:
first preparing a solution combining as the solvent an aqueous liquid, with a first solute being an electrolyte including Group I element ions capable of being hosted in a hosting siliceous element, and a second solute providing the hosting siliceous element;
immersing the at least two conductive electrodes within said solution;
next heating the solution to and maintaining it between a range from 5° C. below and 5° C. above said solution's current boiling point;
then, at least once:
electrically stimulating the at least two conductive electrodes over a time period by applying a voltage while at least one of the conductive electrodes is in contact with a source of siliceous material; and
also photonically stimulating the solution from at least one light source;
until at least one exothermic reaction occurs.

2. A method as in claim 1, wherein the solution of an aqueous liquid comprises any of the set of heavy water (D₂O), light water (H₂O), and any mixture of heavy water (D₂O) and light water (H₂O).

3. A method as in claim 2, wherein after said solution is in the system such that the at least two conductive electrodes are immersed within said solution, the liquid is then blanketed with helium gas.

4. A method as in claim 2, wherein said soluble electrolyte provides lithium ions that can be guests within a soluble siliceous host.

5. A method as in claim 4, wherein said soluble siliceous host is a polyhedral silsesquioxane.

6. A method as in claim 4, wherein said soluble siliceous host is a polyhedral silsesquioxane hydrate-octakis (tetramethylammonium) substituted.

7. A method as in claim 6, wherein the step of photonically stimulating the solution further comprises:
using at least one LED shining through a port in a sidewall of the system; and,
modulating the LED through different frequencies.

8. A method as in claim 6, wherein the step of electrically stimulating the at least two conductive electrodes further comprises applying a time-varying electrical voltage to the at least two conductive electrodes.

9. A method as in claim 6 wherein:
the step of photonically stimulating the solution further comprises:
using at least one LED shining through a port in a sidewall of the system spaced around the sides and aimed at the center; and,
modulating the LED;
and,
the step of electrically stimulating the at least two conductive electrodes further comprises
applying a time-varying electrical voltage to the at least two conductive electrodes;
and,
the photonic and electrical stimuli are applied concurrently.

10. A method as in claim 9, wherein the system further comprises:
a container into which the liquid solution is transferred, said container further comprising:
an interior whose sidewall's interior surface at and around any location where the stimulation will initiate exothermic reactions is comprised of any of the set of glass or siliceous substances, and whose interior surface does not have at any location that will be in contact with the solution any inhibiting substance;
means for heating the solution when it is transferred into the container;
means for electrically stimulating the at least two electrodes connected to said electrodes;
means for photonically stimulating the solution;
and,
means for releasing the pressure inside the container before it is damaged.

11. A method of initiating a desired exothermic reaction, using an aqueous liquid in a system having at least two conductive electrodes but no inhibiting substances in contact with said aqueous liquid, said method comprising: in a solution in a system, comprising:
first preparing a solution combining as the solvent an aqueous liquid, with a first solute being an electrolyte including Group I element ions capable of being hosted in a hosting siliceous element, and a second solute providing the hosting siliceous element;
immersing the at least two conductive electrodes within said solution;
next heating the solution to and maintaining it between a range from 5° C. below and 5° C. above said solution's current boiling point;
then, at least once:
electrically stimulating the at least two conductive electrodes over a time period by applying a voltage to the at least two conductive electrodes while at least one of the conductive electrodes is in contact with a source of siliceous material; and
also photonically stimulating the solution from at least one light source;
and,
initiating the reaction by controllably releasing a fraction of the pressure inside the system after the temperature of the solution exceeds the current pressure boiling point and before the temperature exceeds the pressure release limited boiling point;
until an exothermic reaction occurs during said electrical and photonic stimulation subsequent to said releasing a fraction of the pressure inside the system.

12: A method as in claim 11, wherein the step of initiating the reaction by controllably releasing a fraction of the pressure inside the system, reduces the pressure both within a two-second interval and by no more than 30%.

13: A method as in claim 11, wherein the step of initiating the reaction by controllably releasing the pressure inside the system, reduces the pressure until the temperature of the solution is within 10° C. of its current boiling point.

14: A method as in claim 12, wherein the step of controllably releasing the pressure inside the system reduces the pressure until the temperature of the solution is within 3° C. of its current boiling point.

15. A method as in claim 11, wherein the solute providing the hosting siliceous element is a soluble polyhedral silsesquioxane.

16. A method as in claim 11, wherein the solute providing the hosting siliceous element is a polyhedral silsesquioxane hydrate-octakis (tetramethylammonium) substituted.

17. A method as in claim 16, wherein:
the step of photonically stimulating the solution further comprises:
using at least one LED shining through a port in a sidewall of the system; and,
modulating the LED through different frequencies; and,
the step of electrically stimulating the at least two conductive electrodes further comprises
applying a time-varying electrical voltage;
and,
the photonic and electrical stimuli are applied concurrently.

18. A method as in claim 17, wherein the system further comprises:
a container into which the liquid solution is transferred, said container further comprising:
an interior whose sidewall's interior surface at and around any location where the stimulation will initiate exothermic reactions is comprised of any of the set of glass or siliceous substances, and whose interior surface does not have at any location that will be in contact with the solution any inhibiting substance;
means for heating the solution when it is in the container;
means for electrically stimulating the at least two electrodes connected to said electrodes;
means for photonically stimulating the solution;
and,
means for releasing the pressure inside the container before it is damaged.

19. A method as in claim 18 wherein:
the step of photonically stimulating the solution further comprises:
using at least one white LED capable of 15,000 mcd shining through a port in a sidewall of the container spaced around the sides and aimed at the center; and,
pulse-modulating the LED through the following six frequencies, dwelling at each for five minutes: 464, 1234, 1289, 2008, 3176, and 5000 Hz with 50% duty cycles;
the step of electrically stimulating the at least two conductive electrodes further comprises applying a time-varying electrical signal with an amplitude of 3.3 Volts when driven from a 50-ohm outlet; and,
the step of controllably releasing the pressure inside the system reduces the pressure inside the container until the temperature of the solution is within 5° C. of its current boiling point.

20. A method of initiating a desired exothermic reaction, using an aqueous liquid in a system having at least two conductive electrodes but no inhibiting substances in contact with said aqueous liquid, said method comprising:
first preparing a solution combining as the solvent an aqueous liquid, with a first solute being an electrolyte including Group I element ions capable of being hosted in a hosting siliceous element, and a second solute providing the hosting siliceous element;
placing said solution into the system until the at least two conductive electrodes, at least one which is in intimate contact with a source of siliceous material, are immersed within said solution;
heating the solution for twenty minutes to reach a temperature between 90° C. and 95° C. and dissolving the solutes, then buffering the solution with citric acid until it has a pH between a range of 6.9 and 8.3;
next heating the solution to and maintaining it between a range from 5° C. below and 20° C. above said solution's current boiling point;
then electrically stimulating the at least two conductive electrodes over a time period by applying a voltage while at least one of the conductive electrodes is in contact with a source of siliceous material; and
also photonically stimulating the solution from at least one light source;
and,
controllably releasing a fraction of the pressure inside the system after the temperature of the solution exceeds the current pressure boiling point and before the temperature exceeds the pressure release limited boiling point, both within a two-second interval and by no more than 30%;
until an exothermic reaction occurs during said electrical and photonic stimulation subsequent to said releasing a fraction of the pressure inside the system.
